(19) United States
(12) Patent Application Publication
(10) Pub. No.: US 2026/0111106 A1
(43) Pub. Date: Apr. 23, 2026

(54) APPARATUS AND METHOD FOR DISPLAYING SLIDE INFORMATION

(71) Applicant: CURIOSIS CO.,LTD, Seoul (KR)

(72) Inventors: Minseop PARK, Seoul (KR); Dongyoub BAIK, Seoul (KR); Yujin CHOI, Seoul (KR)

(73) Assignee: CURIOSIS CO.,LTD, Seoul (KR)

(21) Appl. No.: 19/429,286

(22) Filed: Dec. 22, 2025

Related U.S. Application Data
(63) Continuation of application No. PCT/KR2024/008361, filed on Jun. 18, 2024.

(30) Foreign Application Priority Data
Jun. 21, 2023 (KR) 10-2023-0079916
Aug. 2, 2023 (KR) 10-2023-0101160

(51) Int. Cl. G06F 3/04847; G06F 3/0482; G06F 3/0488

(52) U.S. Cl. CPC G06F 3/04847; G06F 3/0482; G06F 3/0488

(57) ABSTRACT

One embodiment of the present disclosure relates to an apparatus for providing slide information. The apparatus identifies at least one slide tray inserted into a slide tray slot, generates a first graphical user interface (GUI) regarding slide trays based on the identified at least one slide tray, identifies at least one slide arranged in each of the at least one slide tray, generates a second GUI regarding slides based on the identified at least one slide, and controls a display to output the first GUI and the second GUI.

### CROSS-REFERENCE TO RELATED APPLICATIONS

This application is a continuation of International Application No. PCT/KR2024/008361 filed on Jun. 18, 2024, which claims priority to Korean Patent Application No. 10-2023-0079916 filed on Jun. 21, 2023 and Korean Patent Application No. 10-2023-0101160 filed on Aug. 2, 2023, the entire contents of which are herein incorporated by reference.

### TECHNICAL FIELD

The present disclosure relates to an apparatus and method for providing information on slide trays and slides accommodated in the slide trays to a user, and more particularly, to an apparatus and method for intuitively displaying information regarding slide trays and slides in synchronization with a slide tray slot.

### BACKGROUND ART

In pathology departments, morphological changes in a patient's cells, tissues, or body fluids are observed and analyzed to make a diagnosis, thereby providing a basis for clinical treatment decisions. Traditionally, cytologic or histologic examinations have been conducted by pathologists visually interpreting cell slides or tissue slides using a microscope. However, with the introduction of digital slide scanners in pathological diagnosis, pathological analysis is now performed not only through microscopy but also using digital images obtained by scanning stained cytology or histology slides

Slides containing patient specimens are accommodated in a tray, and the slide tray is placed in a slide tray slot. A digital slide scanner scans the slide tray accommodated in the slot, and as scanning is performed, information regarding the slides contained in the slide tray is obtained and used for pathological diagnosis.

Accordingly, information on multiple slides can be acquired in a short time, and it is also important to provide such information in a manner that allows the user to conveniently and intuitively identify it. The present disclosure aims to provide a method for allowing a user to intuitively identify information on a plurality of slides.

### SUMMARY

### Technical Objective

An embodiment of the present disclosure is to provide an apparatus and method for displaying slide information.

### Means for Solving Technical Objective

An embodiment of the present disclosure may provide an apparatus and a method for providing slide information by displaying slide information.

An embodiment of the present disclosure aims to provide an apparatus for providing slide information, the apparatus comprising a memory configured to store one or more instructions, and at least one processor configured to execute the one or more instructions stored in the memory. In an embodiment, the at least one processor, by executing the one or more instructions, may be configured to identify at least one slide tray inserted into a slide tray slot, generate a first graphical user interface (GUI) regarding slide trays based on the identified at least one slide tray, identify at least one slide arranged in each of the at least one slide tray, generate a second GUI regarding slides based on the identified at least one slide, and control a display to output the first GUI and the second GUI.

In an embodiment, the first GUI may comprise a GUI representing at least one of position information of the at least one slide tray inserted into the slide tray slot, scan-progress information for at least a portion of the at least one slide tray, slide-tray absence information, identification information of a slot, identification information of a slide tray accommodation unit, or identification information of the at least one slide tray, and the second GUI may comprise a GUI representing at least one of position information of the at least one slide on the slide tray, scan-progress information for at least a portion of the at least one slide, specimen information of the at least one slide, code information of the at least one slide, identification information of the slide tray, or identification information of the at least one slide.

In an embodiment, the at least one processor may be configured to obtain a first user input for selecting a first slide tray among the at least one slide tray based on the first GUI, and to control the display to output a second GUI corresponding to the first slide tray based on the first user input, the second GUI comprising identification information of the first slide tray, wherein the identification information of the first slide tray may comprise at least one of position information indicating a position of the first slide tray within the slide tray slot, scan-status information, information on the number of slides included in the first slide tray, or time information indicating when the first slide tray was inserted into the slide tray slot.

In an embodiment, the first GUI may comprise a GUI representing at least one of a GUI corresponding to a first slide tray whose scanning is completed, a GUI corresponding to a second slide tray that is being scanned, a GUI corresponding to a third slide tray whose pre-scanning is completed or is in progress, a GUI corresponding to a fourth slide tray for which scanning has not yet been performed, a GUI indicating that no slide tray is present in a slide-tray accommodation unit, or a GUI indicating a slide tray that is not a scanning target, wherein a GUI corresponding to the second slide tray that is being scanned may comprise a GUI indicating a degree of scanning progress for slides present in the second slide tray, and a GUI corresponding to the third slide tray for which pre-scanning is completed or is in progress may comprise a GUI indicating a degree of pre-scanning progress for slides present in the third slide tray.

In an embodiment, the first GUI may comprise a GUI regarding a queue-management mode, and the at least one processor may be configured to provide a GUI for changing an order of scanning or pre-scanning of slide trays when the GUI regarding the queue-management mode is selected.

In an embodiment, the second GUI may comprise a GUI representing at least one of a GUI corresponding to a first slide whose scanning is completed, a GUI corresponding to a second slide that is being scanned, a GUI corresponding to a third slide for which scanning has not yet been performed, a GUI indicating that no slide is present in a slide-accommodation unit, or a GUI indicating a slide that is not a scanning target, and a GUI corresponding to the second slide that is being scanned may comprise a GUI indicating a degree of scanning progress for the second slide.

In an embodiment, the at least one processor may be configured to control the display to output a third GUI for selecting not a first slide tray but a second slide tray, when a slide tray corresponding to information currently output through the second GUI is the first slide tray, obtain a second user input for selecting the second slide tray while the second GUI regarding the first slide tray is being output, update the first GUI, the second GUI, and the third GUI based on the second user input, and control the display to output the updated first GUI, the updated second GUI, and the updated third GUI, wherein the second user input may comprise at least one of a user input touching a GUI corresponding to the second slide tray in the first GUI, a user input touching a GUI corresponding to the second slide tray in the third GUI, or a gesture input dragging the display from one direction to another, and wherein, before being updated, the first GUI may comprise a fourth GUI corresponding to the first slide tray and a fifth GUI corresponding to the second slide tray, the fifth GUI being smaller than the fourth GUI, and the updated first GUI may comprise a fourth GUI corresponding to the first slide tray and a fifth GUI corresponding to the second slide tray, the fifth GUI being larger than the fourth GUI.

In an embodiment, the at least one processor may be configured to identify a color corresponding to each of the slide trays in the first GUI, and to transmit a signal to the slide tray slot to control light-emitting elements of each slide-tray accommodation unit of the slide tray slot to emit light having a color corresponding to the color corresponding to each of the slide trays in the first GUI.

In an embodiment, the at least one processor may be configured to receive, from the slide tray slot, color information of light emitted by light-emitting elements of each slide-tray accommodation unit of the slide tray slot, and, based on the color information, to control the display to output at least a portion of the first GUI corresponding to each of the slide trays in a color corresponding to the color of light emitted by the light-emitting elements of the corresponding slide-tray accommodation unit.

An embodiment of the present disclosure aims to provide a method for providing slide information.

In an embodiment, the method for providing slide information may comprise identifying at least one slide tray inserted into a slide tray slot, generating a first GUI regarding slide trays based on the identified at least one slide tray, identifying at least one slide arranged in each of the at least one slide tray, generating a second GUI regarding slides based on the identified at least one slide, and controlling a display to output the first GUI and the second GUI.

In an embodiment, the method for providing slide information may comprise obtaining a first user input for selecting a first slide tray among the at least one slide tray based on the first GUI, and controlling the display to output a second GUI corresponding to the first slide tray based on the first user input, the second GUI comprising identification information of the first slide tray, wherein the identification information of the first slide tray may comprise at least one of position information indicating a position of the first slide tray within the slide tray slot, scan-status information, information on the number of slides included in the first slide tray, or time information indicating when the first slide tray was inserted into the slide tray slot.

In an embodiment, the first GUI may comprise a GUI regarding a queue-management mode, and the method for providing slide information may comprise providing a GUI for changing an order of scanning or pre-scanning of slide trays when the GUI regarding the queue-management mode is selected.

In an embodiment, when a slide tray corresponding to information currently output through the second GUI is the first slide tray, the method for providing slide information may comprise controlling the display to output a third GUI for selecting not the first slide tray but a second slide tray, obtaining a second user input for selecting the second slide tray while the second GUI regarding the first slide tray is being output, updating the first GUI, the second GUI, and the third GUI based on the second user input, and controlling the display to output the updated first GUI, the updated second GUI, and the updated third GUI, wherein the second user input may comprise at least one of a user input touching a GUI corresponding to the second slide tray in the first GUI, a user input touching a GUI corresponding to the second slide tray in the third GUI, or a gesture input dragging the display from one direction to another, and wherein, before being updated, the first GUI may comprise a fourth GUI corresponding to the first slide tray and a fifth GUI corresponding to the second slide tray, the fifth GUI being smaller than the fourth GUI, and the updated first GUI may comprise a fourth GUI corresponding to the first slide tray and a fifth GUI corresponding to the second slide tray, the fifth GUI being larger than the fourth GUI.

In an embodiment, the method for providing slide information may comprise identifying a color corresponding to each of the slide trays in the first GUI, and transmitting a signal to the slide tray slot to control light-emitting elements of each slide-tray accommodation unit of the slide tray slot to emit light having a color corresponding to the color corresponding to each of the slide trays in the first GUI.

In an embodiment, the method for providing slide information may comprise receiving, from the slide tray slot, color information of light emitted by light-emitting elements of each slide-tray accommodation unit of the slide tray slot, and, based on the color information, controlling the display to output at least a portion of the first GUI corresponding to each of the slide trays in a color corresponding to the color of light emitted by the light-emitting elements of the corresponding slide-tray accommodation unit.

An embodiment of the present disclosure may comprise a program stored on a recording medium to cause a computer to execute the method according to an embodiment of the present disclosure.

An embodiment of the present disclosure may comprise a computer-readable recording medium on which a program is recorded for causing a computer to execute the method according to an embodiment of the present disclosure.

An embodiment of the present disclosure may comprise a computer-readable recording medium on which a database used in an embodiment of the present disclosure is recorded.

### ADVANTAGEOUS EFFECT

According to an embodiment of the present disclosure, a UI/UX may be provided that intuitively shows the position of a slide tray within a slide tray slot, the position of slides on the slide tray, and the scanning process of the slides.

### BRIEF DESCRIPTION OF DRAWINGS

FIG. 1 is a perspective view of a slide tray slot into which a slide tray is to be inserted, according to an embodiment of the present disclosure.

FIG. 2 is a view illustrating a slide tray according to an embodiment of the present disclosure.

FIG. 3 is a rear perspective view of a portion of a slide tray slot including guide pins according to an embodiment of the present disclosure.

FIG. 4 is a view illustrating a slide tray in which slides are accommodated according to an embodiment of the present disclosure.

FIG. 5 is a view illustrating UI/UX for intuitively showing a scanning process of slides according to an embodiment of the present disclosure.

FIG. 6 is a view illustrating UI/UX related to an opening/closing door of a slide information providing apparatus according to an embodiment of the present disclosure.

FIGS. 7A to 7C are views illustrating examples of a first graphical user interface (GUI) according to an embodiment of the present disclosure.

FIG. 8 is a view illustrating UI/UX for setting a scanning order of slide trays according to an embodiment of the present disclosure.

FIG. 9 is a view illustrating a warning window when an insertion direction of a slide tray is incorrect according to an embodiment of the present disclosure.

FIG. 10 is a block diagram of a slide tray slot according to an embodiment of the present disclosure.

FIG. 11 is a block diagram of a slide information providing apparatus according to an embodiment of the present disclosure.

### DETAILED DESCRIPTION OF THE INVENTION

In order to clarify the technical spirit of the present disclosure, embodiments of the present disclosure will be described in detail below with reference to the accompanying drawings. In describing the present disclosure, detailed descriptions of well-known functions or components will be omitted when it is determined that such descriptions may unnecessarily obscure the gist of the present disclosure. Even though components having substantially the same functional configuration are shown in different drawings, identical reference numerals and symbols are used for them as far as possible. Where appropriate for convenience of explanation, an apparatus and a method will be described together. The respective operations of the present disclosure are not necessarily required to be performed in the order described, and may be performed in parallel, selectively, or individually.

Terms used in the embodiments of the present disclosure have been selected in consideration of the functions of the present disclosure and are generally used terms at present, but they may vary according to an intention of a person skilled in the art, case law, or the emergence of new technology. In some cases, terms arbitrarily selected by the applicant are used, and in such a case, the meanings thereof will be described in detail in the description of the corresponding embodiment. Accordingly, the terms used in this specification are not to be construed as mere names of terms, but should be defined on the basis of the meanings of the terms and the overall disclosure of the present disclosure.

Throughout the present disclosure, singular expressions may comprise plural expressions unless the context clearly indicates otherwise. Terms such as “comprise” or “have” are intended to specify that features, numbers, steps, operations, components, parts, or combinations thereof are present, and should not be construed as precluding the presence or addition of one or more other features, numbers, steps, operations, components, parts, or combinations thereof. That is, when a part is described as “comprising” a component in the present disclosure, this means that, unless specifically stated to the contrary, the part does not exclude another component but may further comprise another component.

An expression such as “at least one of” modifies an entire list of elements and does not modify the individual elements in the list. For example, the expressions “at least one of A, B, and C” and “at least one of A, B, or C” refer to only A, only B, only C, both A and B, both B and C, both A and C, all of A, B, and C, or any combination thereof.

In addition, terms such as “. . . unit” and “. . . module” described in the present disclosure mean a unit for processing at least one function or operation, and may be implemented by hardware, by software, or by a combination of hardware and software.

Throughout the present disclosure, when a portion is described as being “connected” to another portion, this includes not only a case where the portion is “directly connected” to the other portion but also a case where the portion is “electrically connected” to the other portion with another element interposed therebetween. In addition, when a portion is described as “comprising” a component, this means that, unless specifically stated to the contrary, the portion does not exclude another component but may further comprise another component.

The expression “configured to” (or “set to”) used throughout the present disclosure may, depending on the context, be interchangeably used with, for example, “suitable for”, “having the capacity to”, “designed to”, “adapted to”, “made to”, or “capable of”. The term “configured to” (or “set to”) does not necessarily mean only “specifically designed to” in a hardware sense. Instead, in some cases, the expression “a system configured to ˜” may mean that the system is “capable of ˜” together with other devices or components. For example, the phrase “a processor configured to perform A, B, and C” may mean a dedicated processor (for example, an embedded processor) for performing the operations, or a general-purpose processor (for example, a CPU or an application processor) that may perform the operations by executing one or more software programs stored in a memory.

Terms comprising ordinal numbers, such as first and second, may be used to describe various components, but the components are not limited by the terms. The terms are used only to distinguish one component from another. For example, without departing from the spirit of the present disclosure, a first component may be referred to as a second component, and similarly a second component may be referred to as a first component. The term “and/or” comprises any combination of a plurality of associated items or any one of the plurality of associated items.

Throughout the present disclosure, a slide is a thin flat substrate of an appropriate size on which a specimen or sample is placed for analysis or the like, and the substrate is wholly or partly made of a material such as glass, quartz, plastic, or silicon. The slide may comprise, for example, a slide glass, a structure obtained by placing a specimen on a slide glass and then covering it with a cover glass, and the like, and may also be referred to as a glass slide, a specimen slide, or a microscope slide. Of course, the slide is not limited to these examples.

Throughout the present disclosure, a slide tray is a case for carrying or storing slides, and may also be referred to as a tray, glass plate, slide plate, slide holder, glass holder, slide case, glass case, slide folder, glass folder, or the like.

Throughout the present disclosure, “adsorptive” may mean a property in which atoms, ions, or molecules are adhered to a surface from a gas, a liquid, or a dissolved solid.

On each slide, information corresponding to a pathological sample is indicated in the form of characters, a barcode, a QR code, or the like, and, after receiving information about the pathological sample contained in the slide, a slide scan apparatus may store the information in association with an image of a sample of pathological cells or tissues on the slide. Such a slide scan apparatus may rapidly scan a large number of slides and provide the scanned results to a pathologist or a physician so that a pathological diagnosis process can be carried out more efficiently. In one embodiment, the slide scan apparatus may comprise an apparatus for providing slide information (hereinafter, “slide information providing apparatus”). The slide scan apparatus may comprise a slide tray slot, a display for indicating a scan-progress status of a slide tray, an openable door, a slide tray transfer apparatus, an on/off switch, a light-emitting diode (LED) element for indicating a scan status of the slide tray, a universal serial bus (USB) port, a camera, an image processing apparatus, and the like.

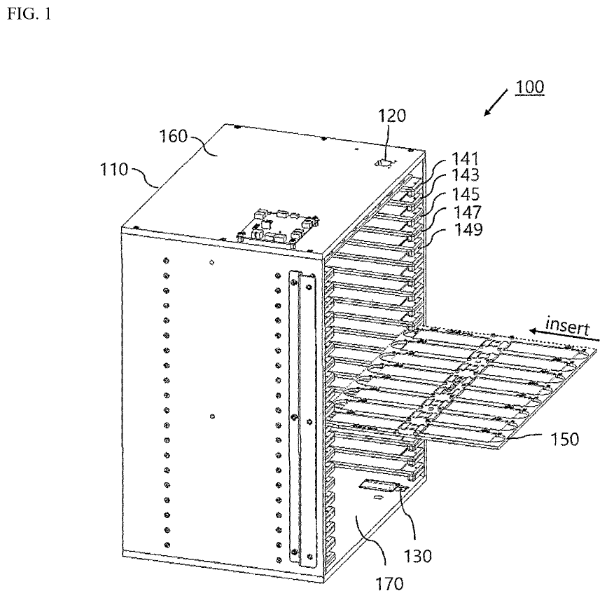

FIG. 1 is a perspective view of a slide tray slot into which a slide tray is to be inserted according to an embodiment of the present disclosure.

Referring to FIG. 1, a slide tray slot 100 may comprise a slot body 110, a light source generator 120, a light source detection sensor 130, and a plurality of slide-tray accommodation units 141, 143, 145, 147, and 149. However, this is merely an example, and the slide tray slot 100 may comprise more components, or may comprise only some of the components illustrated. For example, the slide tray slot 100 may further comprise a light-emitting element corresponding to each of the plurality of slide-tray accommodation units. In one embodiment, the light source generator 120 may be provided on an inner surface of the slot body, and the light source detection sensor 130 may be provided on a surface of the slot body 110 corresponding to a surface on which the light source generator 120 is provided so as to detect light emitted from the light source generator 120. For example, the light source generator 120 may be provided on a ceiling portion 160 of the slot body 110, and the light source detection sensor 130 may be provided on a support portion 170 of the slot body 110. However, this is merely an example, and the light source generator 120 may instead be provided on the support portion 170 and the light source detection sensor 130 may be provided on the ceiling portion 160. For example, the light source generator 120 may emit a laser.

In one embodiment, a plurality of slide-tray accommodation units may be arranged in a vertical stack between a ceiling portion 160 and a support portion 170. A slide tray 150 may be inserted into a slide-tray accommodation unit of a slide tray slot 100.

In one embodiment, a light source generator 120 may emit light in a vertical-stack direction in which the plurality of slide-tray accommodation units are arranged, and a light source detection sensor 130 may detect light emitted when slide trays are properly mounted in the plurality of slide-tray accommodation units.

In one embodiment, each of the plurality of slide-tray accommodation units may comprise a region through which light emitted from the light source generator 120 can pass when a slide tray is properly mounted. Accordingly, when slide trays are properly mounted in the slide tray slot 100, light emitted from the light source generator 120 may reach the light source detection sensor 130, and the light source detection sensor 130 may detect the light.

In one embodiment, the slide tray slot 100 may further comprise a processor (not shown). In one embodiment, the processor may determine that slide trays are properly mounted when a light source is detected by the light source detection sensor 130. Alternatively, in an opposite manner, the processor may determine that the slide trays are properly mounted when a light source is not detected by the light source detection sensor 130. In addition, the processor may output information indicating that the slide trays are properly mounted. For example, the processor may emit light of a particular color (for example, green), may display a particular phrase such as “success,” or may output a particular sound through a speaker. Alternatively, the processor may be located outside the slide tray slot 100.

In one embodiment, when at least one slide tray 150 is not properly mounted in the slide tray slot 100, light emitted from the light source generator 120 may be absorbed or reflected by the slide tray 150 and may not reach the light source detection sensor 130. Accordingly, the light source detection sensor 130 may not detect light emitted from the light source generator 120. Thus, when light is not detected by the light source detection sensor 130, the processor may determine that the slide trays are not properly mounted.

In one embodiment, the processor may identify that light has been emitted by the light source generator 120 and, when light is not detected by the light source detection sensor 130 within a predetermined time period, may determine that a slide tray is not properly mounted in at least one of the plurality of slide-tray accommodation units. In addition, the processor may output information indicating that a slide tray is not properly mounted. For example, the processor may emit light of a particular color, display a particular phrase such as “fail,” or output a particular sound through a speaker.

In one embodiment, one surface of the slide tray 150 may comprise a light-reflective region. In addition, a surface 160 of the slot body 110 on which the light source generator 120 is provided may further comprise a second light source detection sensor (not shown). A processor may identify that light has been emitted by the light source generator 120. In addition, when the slide tray 150 is not properly mounted, light may be reflected by the light-reflective region of the slide tray 150. In addition, when light reflected by the light-reflective region is detected by the second light source detection sensor (not shown), the processor may determine a distance from the light source generator 120 to the one surface of the slide tray 150.

For example, the processor may determine the distance from the light source generator 120 to the one surface of the slide tray 150 based on a difference between a time at which the light is emitted by the light source generator 120 and a time at which the light reflected by the light-reflective region is detected by the second light source detection sensor (not shown). In addition, the processor may identify a position of a slide-tray accommodation unit in which a slide tray is not properly mounted in the slide tray slot 100, based on the distance from the light source generator 120 to the one surface of the slide tray 150. For example, a marker may be formed at a position corresponding to light reflected and detected by the second light source detection sensor (not shown), and information on the position may be output to a display, or a sound indicating the position may be output by using a speaker.

In one embodiment, a light-emitting element may be provided in each of the plurality of slide-tray accommodation units 141, 143, 145, 147, and 149. For example, the light-emitting element may comprise an LED (Light Emitting Diode). A processor of the slide tray slot 100 may transmit, to a slide information providing apparatus, color information of light emitted by light-emitting elements of the respective slide-tray accommodation units 141, 143, 145, 147, and 149, or may receive, from the slide information providing apparatus, color information indicating colors of light to be emitted by light-emitting elements of the respective slide-tray accommodation units 141, 143, 145, 147, and 149, and may control the light-emitting elements to emit light having corresponding colors.

For example, when a light-emitting element is in a green lighting state, a slide tray accommodated in the corresponding slide-tray accommodation unit may be in a scan-completed state, and when the light-emitting element is in a blinking green state, the corresponding slide tray may be being scanned. In addition, when the light-emitting element is in a yellow lighting state, the corresponding slide tray may be in a state in which pre-scanning is completed or is pending, and when the light-emitting element is in a blinking yellow state, a pre-scanning procedure for the corresponding slide tray may be in progress. In addition, when the light-emitting element is turned off, this may indicate that there is no slide tray accommodated in the corresponding slide-tray accommodation unit, and when the light-emitting element is in a blinking red state, this may indicate that an error has occurred. However, this is merely one example and is not limited thereto, and, depending on implementation, light and states emitted by the light-emitting element may imply various kinds of information.

For example, a hole may be formed at a position of the light source generator 120, and whether a slide tray is properly mounted may be determined based on whether a rod inserted into the hole can reach the position of the light source detection sensor 130. In this manner, whether a slide tray is properly mounted may be determined, based on a hole provided in at least one of the ceiling portion 160 and the support portion 170 or based on at least one device, in various ways.

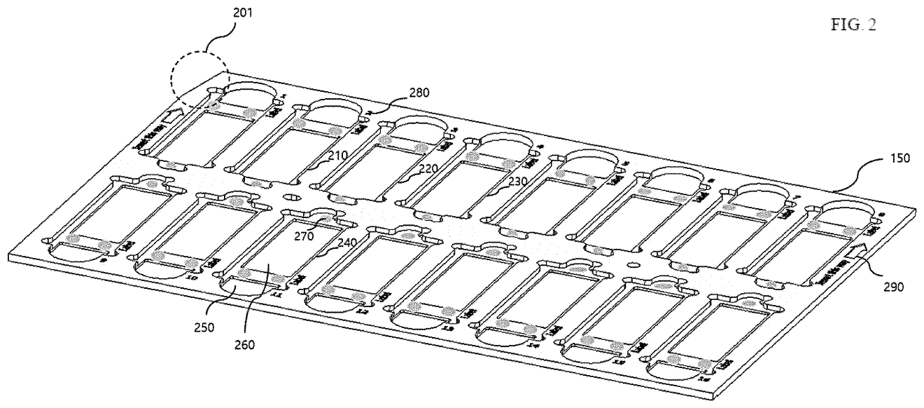

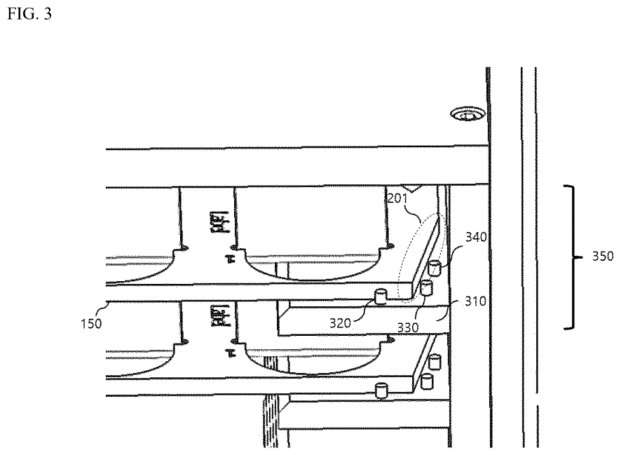

FIG. 2 is a diagram illustrating a slide tray according to an embodiment of the present disclosure.

Referring to FIG. 2, a slide tray 150 may comprise a planar member, and the planar member may comprise an end region 201 having a form in which a portion of a corner is cut from a rectangular shape. Because the end region 201 is present, it may be easy to check whether the slide tray 150 has been properly mounted in a slide tray slot.

In one embodiment, a plurality of slide-accommodation units may be formed on one surface of the planar member as grooves capable of accommodating slides. For example, the plurality of slide-accommodation units may comprise a first slide-accommodation unit 210, a second slide-accommodation unit 220, a third slide-accommodation unit 230, and a fourth slide-accommodation unit 240. In one embodiment, the plurality of slide-accommodation units may be formed as grooves having a depth greater than a thickness of a slide from the planar member.

In one embodiment, a plurality of slide-accommodation units may be formed on the planar member at predetermined intervals. For example, referring to the slide tray 150 of FIG. 2 as an example, eight slide-accommodation units including a first slide-accommodation unit 210, a second slide-accommodation unit 220, and a third slide-accommodation unit 230 may be formed at predetermined intervals in a first row of the planar member, and eight slide-accommodation units including a fourth slide-accommodation unit 240 may be formed at predetermined intervals in a second row different from the first row. In addition, the slide-accommodation units formed in the first row and the slide-accommodation units formed in the second row may be formed with predetermined intervals therebetween. However, this is merely an example, and the number of slide-accommodation units included in the slide tray 150, a shape of the planar member, and a configuration in which the plurality of slide-accommodation units are formed at predetermined intervals are not limited thereto and may be variously modified.

In one embodiment, each of the plurality of slide-accommodation units may comprise a first hollow portion 250 and a second hollow portion 260. However, this is merely an example, and each of the plurality of slide-accommodation units may comprise at least one of a hollow portion corresponding to the first hollow portion 250 and a hollow portion corresponding to the second hollow portion 260, and may further comprise a hollow portion other than the hollow portion corresponding to the first hollow portion 250 and the hollow portion corresponding to the second hollow portion 260.

In one embodiment, the first hollow portion 250 may be a hollow portion for lifting, from a slide-accommodation unit, a slide accommodated therein, and a user of the slide tray 150 may conveniently lift a slide stacked on the slide tray 150 by using the first hollow portion 250. Accordingly, the first hollow portion 250 may correspond to a hole having a size suitable for gripping a slide with a human finger. In one embodiment, the first hollow portion 250 may comprise an outer curved portion. For example, the first hollow portion 250 may have a shape formed of a circle, a semicircle, or a portion of a circumference and a straight line.

In one embodiment, in order to allow a slide to be detachably mounted in a slide-accommodation unit, an adsorptive film 270 having adsorptivity may be attached to at least a portion of each of the plurality of slide-accommodation units. In addition, a plurality of adsorptive films 270 may be attached. The adsorptive film 270 may serve to fix a relative position between a slide and a slide-accommodation unit when the slide is accommodated in the slide-accommodation unit. When a slide is accommodated in a slide-accommodation unit, a bonding force between the slide and the slide-accommodation unit may be generated by the adsorptive film. For example, the bonding force between the slide and the slide-accommodation unit may be an intermolecular bonding force including electrostatic force.

In one embodiment, the adsorptive film 270 may comprise, for example, an electrostatic-force film, a porous adsorption film, a film using Van der Waals force, a covalent-bond-force film, or a tacky film. For example, when a porous adsorption film is used, a slide may be accommodated in a slide-accommodation unit by a vacuum adsorption scheme through a porous material between the slide and the slide-accommodation unit. In addition, as an example of the tacky film, a tacky tape may be used.

According to one embodiment, by using the adsorptive film 270 to increase a fixing force between a slide tray and a slide, it may not be necessary to supply energy other than an appropriate external force when lifting the slide. Accordingly, since other equipment such as a spring, an electric wire, or an air pipe is not required, a manufacturing cost of the slide tray may be reduced.

In one embodiment, the adsorptive film 270 may comprise a base of a polymer-based material and a coating layer made of a resin material. According to one embodiment, by using the coating layer made of a resin material, repeated use of the slide tray may be possible. Furthermore, when an adsorption force of the adsorptive film deteriorates due to many repeated uses, the adsorptive film may be replaced with a new one.

In one embodiment, the first hollow portion 250 may be a hollow portion for lifting, from a fourth slide-accommodation unit 240, a slide accommodated in the fourth slide-accommodation unit 240. When a slide is accommodated on one surface of the fourth slide-accommodation unit 240, a partial region of the first hollow portion 250 may be covered, in a direction perpendicular to one surface of the planar member, by the slide, and another region may be exposed, in a direction perpendicular to one surface of the planar member.

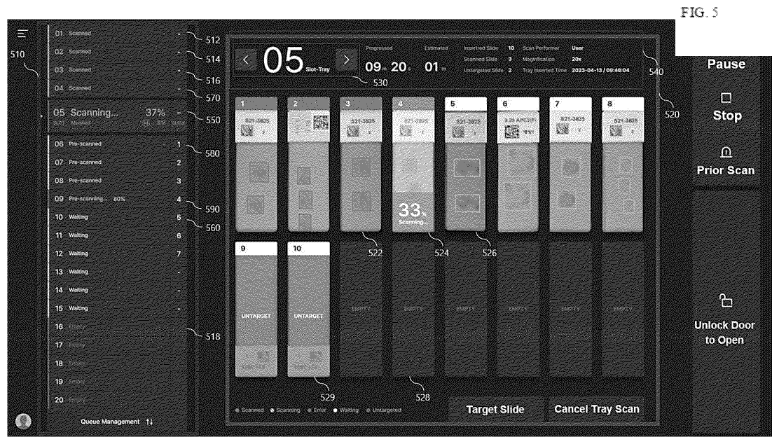

FIG. 5 is a view illustrating a UI/UX for intuitively showing a scanning process of slides according to an embodiment of the present disclosure.

Referring to FIG. 5, a slide information providing apparatus may control a display to output various graphical user interfaces (GUIs) 510. In one embodiment, the display may be a display device included in the slide information providing apparatus, or may be a display device provided separately from the slide information providing apparatus.

In one embodiment, GUIs generated by the slide information providing apparatus may comprise at least one of: a first GUI 510 regarding at least one slide tray located in a slide tray slot; a second GUI 520 regarding at least one slide located on a slide tray; and a third GUI 530 for selecting another slide tray that is not a slide tray corresponding to information currently output through the second GUI 520.

In one embodiment, the slide information providing apparatus may identify that at least one slide tray is inserted into a slide tray slot 100. For example, insertion of a slide tray may be detected by a sensor provided in each of a plurality of slide-tray accommodation units 141, 143, 145, 147, and 149, and the slide information providing apparatus may receive, from the slide tray slot 100, information on slide-tray accommodation units into which slide trays have been inserted. In addition, a light-emitting element may be provided in each of the plurality of slide-tray accommodation units, and the slide tray slot 100 may transmit, to the slide information providing apparatus, light information of the light-emitting elements. Accordingly, the slide information providing apparatus may identify whether a slide tray is accommodated in each of the plurality of slide-tray accommodation units and what color of light is output from each of the plurality of slide-tray accommodation units.

In one embodiment, the slide information providing apparatus may, based on information received from the slide tray slot 100, identify at least one slide tray inserted into the slide tray slot 100, and may, based on the identified at least one slide tray, generate the first GUI 510 regarding at least one slide tray located in the slide tray slot. For example, the first GUI 510 may comprise a GUI representing at least one of: position information of the at least one slide tray inserted into the slide tray slot; scan-progress information for at least a portion of the at least one slide tray; slide-tray absence information; slot identification information; identification information of the at least one slide tray; and information on a scan order of slide trays or a queue-management mode (Queue Management).

In one embodiment, the first GUI 510 representing position information of the at least one slide tray inserted into the slide tray slot in the slide tray slot 100 may be formed to correspond to slide-tray accommodation units arranged in a vertical stack of the slide tray slot 100. For example, based on the fact that, in the slide tray slot 100 described above with reference to FIG. 1, a first slide-tray accommodation unit 141, a second slide-tray accommodation unit 143, and a third slide-tray accommodation unit 145 are three slide-tray accommodation units from the top, the first GUI 510 may comprise, in order from the top, a GUI 512 corresponding to the first slide-tray accommodation unit 141, a GUI 514 corresponding to the second slide-tray accommodation unit 143, and a GUI 516 corresponding to the third slide-tray accommodation unit 145. According to one embodiment, the slide information providing apparatus may provide an intuitive UI/UX by synchronizing positions of slide-tray accommodation units or slide trays in the slide tray slot 100 with GUIs.

In one embodiment, the first GUI 510, which represents the scan-progress information for at least a portion of the at least one slide tray, may comprise, for each slide tray, at least one of: an indication that scanning is completed (scanned); an indication that scanning is being performed (scanning); an indication that pre-scanning is completed (pre-scanned); an indication that pre-scanning is in progress (pre-scanning); and an indication that scanning has not been started (waiting). Pre-scanning refers to a process of acquiring a preview image before scanning each slide located on a slide tray, in order to recognize information on the slide tray, slides, or pathological samples; for example, information on slides may comprise at least one of: whether a slide is present in each slide-accommodation unit; whether a slide in each slide-accommodation unit is damaged; whether a slide is accommodated at a correct position in each slide-accommodation unit; and information on a region of interest in which a pathological sample is present within a slide, and information on the pathological sample may comprise at least one of: a specimen site of the pathological sample; a specimen collection time; whether the specimen is stained; a staining reagent name; and patient information corresponding to the pathological sample. In addition, when scanning or pre-scanning of a slide tray is in progress, the scan-progress information may comprise information regarding a degree of progress of scanning or pre-scanning. For example, the first GUI 510 may comprise a GUI indicating that a slide tray located at a fifth position from the top of the slide tray slot 100 is being scanned and that 37% of scanning has been completed, and a GUI indicating that a slide tray located at a ninth position from the top of the slide tray slot 100 is being pre-scanned and that 80% of pre-Scanning

### Has Been Completed.

In one embodiment, the first GUI 510 may comprise at least one of: a GUI 512, 514, and 516 corresponding to a first slide tray whose scanning is completed; a GUI 550 corresponding to a second slide tray that is being scanned; GUIs 580 and 590 corresponding to a third slide tray whose pre-scanning is completed or is in progress; a GUI 560 corresponding to a fourth slide tray for which scanning has not yet been performed; a GUI 518 indicating that no slide tray is present in a slide-tray accommodation unit; or a GUI indicating a slide tray that is not a scanning target. Throughout the present disclosure, a slide tray that is being scanned may refer to a slide tray in which a scanning procedure for at least one slide present in the slide tray is in progress. A GUI corresponding to a slide tray that is being scanned may comprise a GUI indicating a degree of scanning progress for slides present in the slide tray. For example, the GUI 550 corresponding to the second slide tray that is being scanned in FIG. 5 may be configured to indicate that scanning has been completed to 37%. In another example, the GUI 590 corresponding to the third slide tray that is being pre-scanned in FIG. 5 may be configured to indicate that pre-scanning has been completed to 80%.

In one embodiment, the GUI 512, 514, and 516 corresponding to the first slide tray whose scanning is completed, the GUI 550 corresponding to the second slide tray that is being scanned, the GUIs 580 and 590 corresponding to the third slide tray whose pre-scanning is completed or is in progress, the GUI 560 corresponding to the fourth slide tray for which scanning has not yet been performed, the GUI 518 indicating that no slide tray is present in a slide-tray accommodation unit, and the GUI indicating a slide tray that is not a scanning target may be configured to be distinguishable from one another. For example, GUIs corresponding to the first or second slide tray whose scanning is completed or is being performed may be configured in green, the GUIs 580 and 590 corresponding to the third slide tray whose pre-scanning is completed or is in progress may be configured in yellow, and the GUI 560 corresponding to the fourth slide tray for which scanning has not yet been performed, the GUI 518 indicating that no slide tray is present in a slide-tray accommodation unit, and a GUI (not shown) indicating a slide tray that is not a scanning target may be configured in an achromatic color.

In one embodiment, the slide information providing apparatus may, from the first GUI 510 comprising the GUI 512, 514, and 516 corresponding to the first slide tray whose scanning is completed, the GUI 550 corresponding to the second slide tray that is being scanned, the GUIs 580 and 590 corresponding to the third slide tray whose pre-scanning is completed or is in progress, the GUI 560 corresponding to the fourth slide tray for which scanning has not yet been performed, the GUI 518 indicating that no slide tray is present in a slide-tray accommodation unit, and the GUI indicating a slide tray that is not a scanning target, obtain a user input for clicking or touching a GUI corresponding to one slide tray. In one embodiment, the slide information providing apparatus may receive a user input for clicking or touching the GUI 550 corresponding to the second slide tray. Based on the user input, the slide information providing apparatus may generate the second GUI 520 corresponding to the second slide tray, and may control the display to output the second GUI 520. In addition, the slide information providing apparatus may update the first GUI 510 based on the user input. For example, the slide information providing apparatus may update the first GUI 510 by forming, in the first GUI 510, the GUI 550 corresponding to the second slide tray larger than GUIs corresponding to other slide trays.

Furthermore, the first GUI 510 may comprise the GUI 518 indicating slide-tray absence information, and GUIs indicating slot identification information, slide-tray-accommodation-unit identification information, identification information of slide trays, and the like. In one embodiment, the slide-tray-accommodation-unit identification information may comprise at least one of an identification number of a slide-tray accommodation unit and color information of light emitted by a light-emitting element of the slide-tray accommodation unit. According to one embodiment, the slide information providing apparatus may provide an intuitive UI/UX to a user by synchronizing a color of light emitted by the light-emitting element of each slide-tray accommodation unit with a color of a UI corresponding to each slide-tray accommodation unit in the first GUI 510.

In one embodiment, the slide information providing apparatus may identify that at least one slide tray is inserted into the slide tray slot. For example, a slide scan apparatus may scan the slide tray slot and may transmit, to the slide information providing apparatus, position information of slide trays inserted into the slide tray slot and position information of slides accommodated on the slide trays. In one embodiment, the slide scan apparatus and the slide tray slot 100 may comprise one additional apparatus (for example, the slide information providing apparatus). The slide information providing apparatus may identify whether slides are accommodated on slide trays, positions of slides accommodated on the slide trays, and the numbers of slides accommodated on the slide trays.

In one embodiment, the slide information providing apparatus may, based on information received from the slide scan apparatus, identify at least one slide arranged on each slide tray, and may, based on the identified at least one slide, generate the second GUI 520 regarding slides. For example, the second GUI 520 may comprise a GUI representing at least one of: position information of the at least one slide on the corresponding slide tray; scan-progress information for at least a portion of the at least one slide; specimen information of the at least one slide; code information of the at least one slide; identification information of the slide tray; or identification information of the at least one slide.

In one embodiment, the second GUI 520 may comprise at least one of: a GUI 522 corresponding to a first slide whose scanning is completed; a GUI 524 corresponding to a second slide that is being scanned; a GUI 526 corresponding to a third slide for which scanning has not yet been performed; a GUI 528 indicating that no slide is present in a slide-accommodation unit; and a GUI 529 indicating a slide that is not a scanning target. In addition, the GUI 524 corresponding to the second slide that is being scanned may comprise a GUI indicating a degree of scanning progress for the second slide. For example, when scanning of the second slide has progressed to 33%, the GUI 524 corresponding to the second slide may be configured to indicate that 33% has progressed.

In one embodiment, the second GUI representing position information of at least one slide on a slide tray may correspond to actual positions of slides on the slide tray. For example, when a slide tray comprises slide-accommodation units that can accommodate eight slides per row in two rows, the slide information providing apparatus may generate and provide the second GUI 520 as a second GUI in which slide-accommodation units corresponding to a 2-row by 8-column arrangement are formed. In addition, as illustrated in FIG. 5, when only eight slides of a first row and two slides on a left side of a second row exist among slides in the 2-row by 8-column arrangement on an actual slide tray, the slide information providing apparatus may generate and provide slide-shaped GUIs at positions corresponding to the eight slide-accommodation units in the first row and the two slide-accommodation units on the left side of the second row among GUIs corresponding to the 2-row by 8-column slide-accommodation units. According to one embodiment, a UI/UX that allows a user to intuitively recognize positions of slides on a slide tray may be provided.

In one embodiment, the scan-progress information for at least a portion of at least one slide may comprise scan-progress information for slides among at least one slide that are identified as being present on a slide tray and that have completed scanning or are being scanned. Referring to FIG. 5 as an example, based on the fact that scanning of slides having identification numbers 1 to 3 has been completed, the slide information providing apparatus may provide a GUI indicating that scanning of the slides having identification numbers 1 to 3has been completed. For example, the slide information providing apparatus may provide GUIs including a phrase indicating scan completion, or may provide GUIs by distinguishing, with a color different from GUIs corresponding to slides for which scanning has not been completed (for example, slides having identification numbers 5 to 8), GUIs corresponding to slides for which scanning has been completed. For example, the slide information providing apparatus may generate GUIs corresponding to slides for which scanning has been completed or is being performed in chromatic colors and may generate GUIs corresponding to slides scheduled to be scanned in achromatic colors. In one embodiment, the slide information providing apparatus may, based on the fact that scanning of the slide having identification number 4 is in progress, provide the GUI 524 comprising scan-progress information for scanning of the slide having identification number 4. The scan-progress information for scanning of a slide may comprise at least one of information on a degree of scan progress and information indicating whether scan progress is in progress.

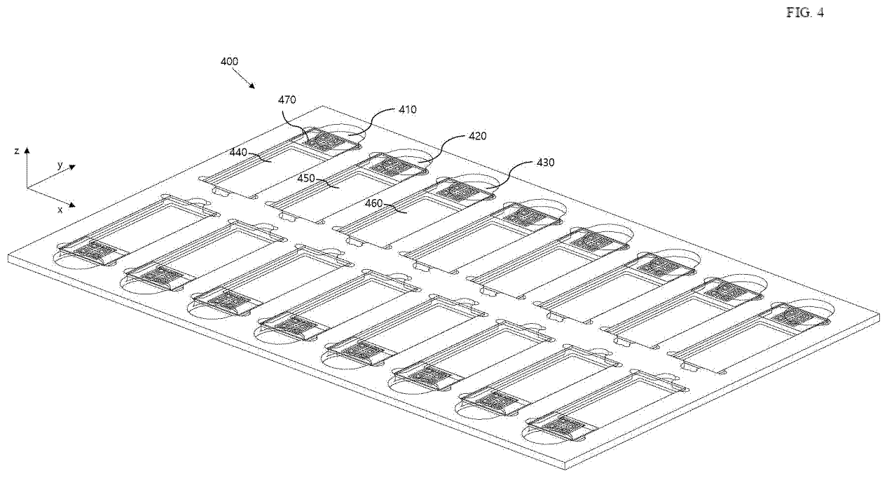

In one embodiment, the slide information providing apparatus may generate the second GUI 520, which indicates at least one of the position information of at least one slide on the slide tray, the scan-progress information for at least a portion of the at least one slide, the specimen information of the at least one slide, the code information of the at least one slide, the identification information of the slide tray, and the identification information of the at least one slide, so as to correspond to the slides of FIG. 4.

In one embodiment, the slide information providing apparatus may, based on the first GUI 510, obtain a first user input for selecting a first slide tray among the at least one slide tray. In addition, the slide information providing apparatus may, based on the first user input, control the display to output the second GUI 520 corresponding to the first slide tray and comprising identification information 540 of the first slide tray. The identification information 540 of the first slide tray may be information on the slide tray selected by a user through the first GUI 510, and may comprise at least one of: position information indicating a position of the first slide tray within the slide tray slot; scan-status information of the first slide tray; information on the number of slides included in the first slide tray; and time information indicating when the first slide tray was inserted into the slide tray slot.

In one embodiment, the position information indicating the position of the first slide tray within the slide tray slot may comprise information on which numbered stack the slide tray is located in when slide-tray accommodation units are arranged in a stack in the slide tray slot. For example, when the first slide tray is a slide tray inserted into a slide-tray accommodation unit at a fifth position from the top, if the slide information providing apparatus receives, through the first GUI 510, a user input corresponding to the slide tray at the fifth position, the slide information providing apparatus may control the display, through the second GUI 520, to output a phrase such as “05 Slot-Tray.”

In one embodiment, the scan-status information may comprise information regarding at least one of: a progressed time of scanning; an estimated time remaining until completion of scanning; the number of slides that have been scanned; the number of slides for which scanning has not yet been completed; a magnification for scanning; and a scan performer.

In one embodiment, when a slide tray is inserted into a slide-tray accommodation unit, the slide tray slot may store an insertion time and may transmit the insertion time information to the slide information providing apparatus. The slide information providing apparatus may, based on the time information received from the slide tray slot, control the display to output the time information indicating when the slide tray was inserted into the slide tray slot.

In one embodiment, the slide information providing apparatus may control the display to output the third GUI 530 together with the second GUI 520. The third GUI 530 may comprise a GUI for selecting a second slide tray that is not the first slide tray, when a slide tray corresponding to information currently output through the second GUI 520 is the first slide tray. For example, the third GUI 530 may comprise a GUI for selecting a slide tray that is immediately before or after the first slide tray.

In one embodiment, while outputting the second GUI 520 regarding the first slide tray, the slide information providing apparatus may, while the second GUI 520 regarding the first slide tray is being output, obtain a second user input for selecting a second slide tray that is not the first slide tray. The second user input may comprise at least one of: a user input touching a GUI corresponding to the second slide tray in the first GUI 510; a user input touching a GUI corresponding to the second slide tray in the third GUI 530; and a gesture input dragging the display from one direction to another. In addition, the slide information providing apparatus may, based on the second user input, update at least one of the first GUI 510, the second GUI 520, and the third GUI 530. For example, before the second user input is obtained, the first GUI 510 may comprise a fourth GUI 550 corresponding to the first slide tray (05 Slot-Tray in FIG. 5) and a fifth GUI 570 corresponding to the second slide tray (04 Slot-Tray in FIG. 5), and, because information currently output through the second GUI 520 is information regarding the first slide tray, the fifth GUI 570 may be formed smaller than the fourth GUI 550. For example, when information currently output through the second GUI 520 is information on the 05 Slot-Tray, the fourth GUI 550 may be formed larger than the fifth GUI 570. In this case, the slide information providing apparatus may obtain, through the third GUI 530, a user input for selecting the 04 Slot-Tray, which is a tray preceding the 05 Slot-Tray. Accordingly, the slide information providing apparatus may update the second GUI 520 such that information displayed through the second GUI 520 corresponds to the second slide tray (04 Slot-Tray), and may update the first GUI 510 such that the fifth GUI 570 corresponding to the second slide tray (04 Slot-Tray) is formed larger than the fourth GUI 550 corresponding to the first slide tray (05 Slot-Tray). Accordingly, the fourth GUI 550 corresponding to the first slide tray (05 Slot-Tray) may become the same size as GUIs corresponding to slide trays other than the second slide tray (04 Slot-Tray).

According to an embodiment of the present disclosure, various slide-information providing functions may be provided intuitively by allowing a user to modify a region of interest (ROI) through a user input such as a touch input.

In one embodiment, the slide information providing apparatus may identify a color corresponding to each of the slide trays in the first GUI 510 and may transmit, to the slide tray slot, a signal for controlling light-emitting elements of each slide-tray accommodation unit of the slide tray slot to emit light having a color corresponding to the color corresponding to each of the slide trays in the first GUI 510. Alternatively, the slide information providing apparatus may receive, from the slide tray slot, color information of light emitted by light-emitting elements of each slide-tray accommodation unit of the slide tray slot, and may, based on the color information, control the display to output at least a portion of the first GUI 510 corresponding to slide trays of each slide-tray accommodation unit in a color corresponding to the color of light emitted by the light-emitting elements of the respective slide-tray accommodation units.

According to an embodiment of the present disclosure, by synchronizing colors of light of light-emitting elements of respective slide-tray accommodation units of an actual slide tray slot with colors of GUIs provided by the slide information providing apparatus, an intuitive UI/UX may be provided to a user.

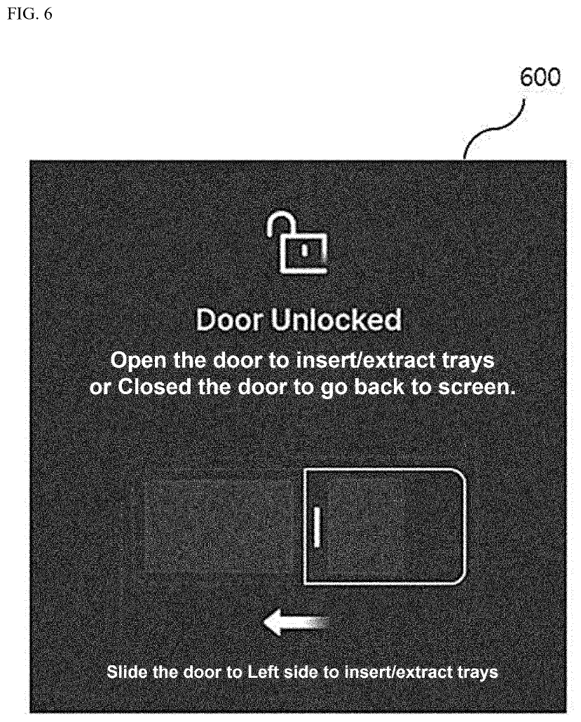

FIG. 6 is a view illustrating UI/UX related to an opening/closing door of a slide information providing apparatus according to an embodiment of the present disclosure.

Referring to FIG. 6, UI/UX related to an opening/closing door of the slide information providing apparatus may be provided. In one embodiment, when a user input for a door-unlock button of the opening/closing door is received, the slide information providing apparatus may control a display to provide a popup interface related to the opening/closing door. The popup interface related to the opening/closing door may be displayed so as to indicate at least one of a direction in which the opening/closing door is to be moved and a degree to which the opening/closing door is to be moved in order to open or close the opening/closing door. In addition, the slide information providing apparatus may identify a degree to which the opening/closing door has been moved, and the popup interface related to the opening/closing door may be displayed so as to indicate the degree to which the opening/closing door has been moved. The slide information providing apparatus may identify whether the opening/closing door has moved to a predetermined position, and, when it is identified that the opening/closing door has moved to the predetermined position, may control the display such that the popup interface related to the opening/closing door is no longer provided. Likewise, an interface related to closing of the opening/closing door may be provided when the opening/closing door is closed. According to one embodiment, a user may move the opening/closing door until an interface screen changes through UI/UX related to the opening/closing door output on the display and, when opening or closing the opening/closing door, may check through the UI/UX whether the door has been properly opened or closed, thereby increasing user convenience in using the slide information providing apparatus.

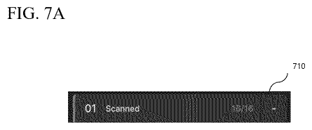

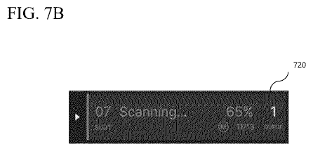

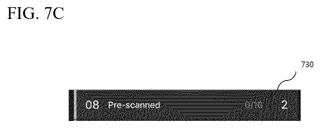

FIGS. 7A to 7C are views illustrating examples of a first GUI according to an embodiment of the present disclosure.

In one embodiment, the first GUI may comprise, as illustrated in FIG. 7A, a GUI 710 for displaying information regarding a slide tray whose scanning is completed, as illustrated in FIG. 7B, a GUI 720 for displaying information regarding a slide tray that is being scanned, and, as illustrated in FIG. 7C, a GUI 730 for displaying information regarding a slide tray whose pre-scanning is completed, and may further comprise a GUI (not shown) for displaying information regarding a slide tray that is being pre-scanned, a GUI (not shown) for displaying information regarding a slide tray that is waiting before scanning is started, and a GUI (not shown) for indicating that a slide-tray accommodation unit is empty.

In one embodiment, the first GUI may comprise, as illustrated in FIG. 7A, a GUI 710 for displaying information regarding a slide tray whose scanning is completed, as illustrated in FIG. 7B, a GUI 720 for displaying information regarding a slide tray that is being scanned, and, as illustrated in FIG. 7C, a GUI 730 for displaying information regarding a slide tray whose pre-scanning is completed. In addition, the first GUI may further comprise a GUI indicating that no slide tray is present in a slide-tray accommodation unit and a GUI indicating a slide tray that is not a scanning target.

Referring to FIG. 7A, a GUI 710 for displaying information regarding a slide tray whose scanning is completed may display information on the number of slides mounted on the slide tray and the number of slides whose scanning has been completed in the slide tray. For example, the GUI 710 may display information in a form of “A/B,” in which A indicates the number of slides whose scanning has been completed in the slide tray and B indicates the number of slides mounted on the slide tray. For example, when “16/16” is displayed, this may indicate that, among sixteen slides mounted on the slide tray, all sixteen slides have completed scanning.

Referring to FIG. 7B, a GUI 720 for displaying information regarding a slide tray that is being scanned may comprise scan-progress information for slides present on the slide tray, information on the number of slides present on the slide tray, information on the number of slides whose scanning has been completed, and the like. For example, the scan-progress information may be provided, as illustrated in FIG. 7B, in the form of a percentage, or may be provided in the form of a progress gauge that fills from left to right or from bottom to top. A display such as “11/13” in FIG. 7B may indicate that scanning has been completed for 11 slides among 13 slides present on the slide tray. In the notation “A/B,” A may represent the number of slides whose scanning has been completed in the slide tray, and B may represent the number of slides mounted on the slide tray.

Referring to FIG. 7C, a GUI 730 for displaying information regarding a slide tray whose pre-scanning is completed may display information in a form of “A/B,” in which A indicates the number of slides whose scanning has been completed and B indicates the number of slides mounted on the slide tray. In particular, when scanning has not yet been started after pre-scanning has been completed, “0/B” may be displayed, and, when “0/16” is displayed, this may indicate that sixteen slides are present on the slide tray and that scanning of the slides has not yet been started.

In addition to FIGS. 7A to 7C, a GUI for displaying information regarding a slide tray that is being pre-scanned may comprise pre-scanning progress information. For example, the pre-scanning progress information may be provided in the form of numerical information indicating a degree of pre-scanning progress of the slide tray, or may be provided in the form of a progress gauge that fills from left to right or from bottom to top.

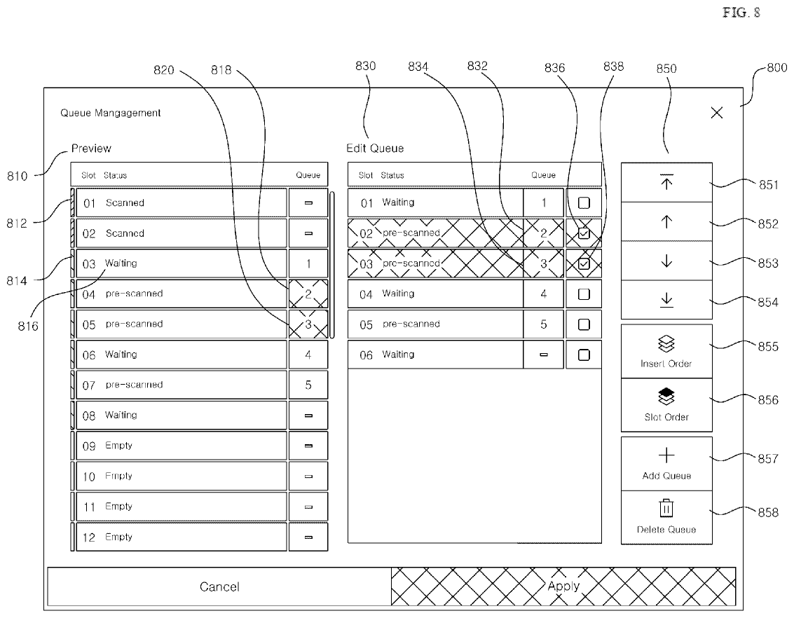

FIG. 8 is a view illustrating UI/UX for setting a scanning order of slide trays according to an embodiment of the present disclosure.

Referring to FIG. 8, a slide information providing apparatus may, as a default option, set a scanning order of slide trays according to positions of slide trays in a slide tray slot, and an interface 800 for setting a scanning order may comprise a preview-area interface 810, scan-order interfaces 818 and 820, a queue-edit area interface (Edit Queue) 830, and an order-change interface 850.

In one embodiment, through the preview-area interface 810, information such as identification numbers of slide trays, information on whether a slide tray is mounted in each slide-tray accommodation unit of a slide tray slot, scan-status information for each slide tray, and information related to a scanning order of slide trays may be provided.

In one embodiment, sixth GUIs 812 and 814 formed in the preview-area interface 810 may be formed to correspond to light information of light-emitting elements of corresponding slide-tray accommodation units. For example, when a slide tray (for example, tray No. 02 in FIG. 8) accommodated in a slide-tray accommodation unit is in a scan-completed state, a light-emitting element of the corresponding slide-tray accommodation unit may be in a green lighting state, and the sixth GUI 812 may be output in a green lighting state corresponding to the light-emitting element.

In another example, when a slide tray is being scanned, a corresponding light-emitting element may be in a blinking green state, and the corresponding sixth GUI may be output in a blinking green state. In addition, when a corresponding slide tray is in a state in which pre-scanning is completed or is pending, the corresponding light-emitting element may be in a yellow lighting state, and the corresponding sixth GUI 814 may likewise be output in a yellow lighting state. In addition, when a pre-scanning procedure for a corresponding slide tray is in progress, the corresponding light-emitting element may be in a blinking yellow state, and the slide information providing apparatus may output the corresponding sixth GUI in a blinking yellow state. In addition, when a light-emitting element is turned off, this may indicate that there is no slide tray accommodated in the corresponding slide-tray accommodation unit, and the corresponding sixth GUI may have a gray or achromatic color. When a light-emitting element is in a blinking red state, this may indicate that an error has occurred, and the corresponding sixth GUI may be formed in red. However, this is merely one example and is not limited thereto, and, after identifying light information of the light-emitting element, the slide information providing apparatus may output the preview-area interface 810 such that the corresponding sixth GUI corresponds to the light information of the light-emitting element. According to one embodiment, the slide information providing apparatus may provide UI/UX that allows a user to intuitively check scan-progress information of slide trays.

In one embodiment, scan-order interfaces 818 and 820 formed in the preview-area interface 810 may represent scan-order information of corresponding slide trays. For example, in the interface of FIG. 8, slide tray No. 03 may have a first scan order, and slide tray No. 04 may have a second scan order.

In one embodiment, a queue-edit area interface 830 may comprise information for changing a scanning order and a user interface for changing and displaying the scanning order. For example, the queue-edit area interface 830 may comprise a scan-order information interface 832 for listing slide trays in a scanning order and a scan-order information interface 834 for listing slide trays not assigned a scanning order. In addition, the scan-order information interfaces 832 and 834 may correspond to the scan-order interfaces 818 and 820 formed in the preview-area interface 810.

In one embodiment, the queue-edit area interface 830 may further comprise check box interfaces 836 and 838. Based on providing the check box interfaces, the slide information providing apparatus may receive a user input for selecting one or more slide trays, may display a check mark in a check box interface corresponding to a slide tray selected by the user input, and may further display at least a portion of a region corresponding to the selected slide tray so as to be distinguished from other regions. For example, when slide tray No. 04 and slide tray No. 05 are selected by a user, the slide information providing apparatus may display at least a portion of interfaces corresponding to slide tray No. 04 and slide tray No. 05 (for example, scan-order interfaces 818 and 820 formed in the preview-area interface 810 or corresponding regions formed in the queue-edit area interface 830) so as to be distinguished from other interfaces.

In one embodiment, an order-change interface 850 may comprise an interface 851 for moving a scan order of a selected slide tray to a foremost order, an interface 852 for moving a scan order of a selected slide tray to an immediately previous order, an interface 853 for moving a scan order of a selected slide tray to an immediately subsequent order, an interface 854 for moving a scan order of a selected slide tray to a last order, an interface 855 for scanning slide trays in an order in which the slide trays are inserted into the slide tray slot, an interface 856 for scanning slide trays in an order in which the slide trays are arranged in the slide tray slot, an interface 857 for assigning scan orders to slide trays to which scan orders have not been assigned, and an interface 858 for deleting scan orders assigned to slide trays to which scan orders have been assigned. However, this is merely one example, and various interfaces for allowing a user to easily change a scan order may be comprised, and an arrangement order thereof may also be variously modified.

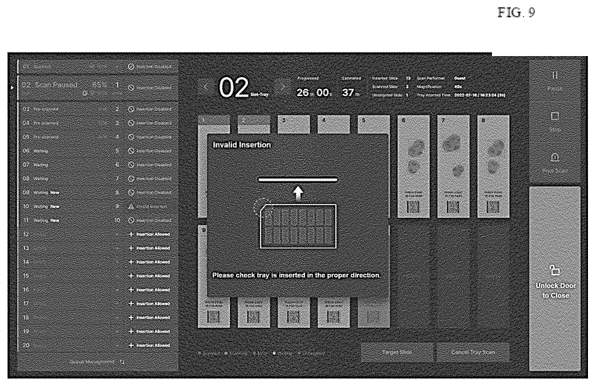

FIG. 9 is a view illustrating warning windows according to an embodiment of the present disclosure, in which FIG. 9A illustrates a warning window when a slide tray is inserted in an incorrect direction (FIG. 9A), and FIG. 9B illustrates a warning window when a slide tray is inserted into a tray position in which scanning is in progress (FIG. 9B).

Referring to FIG. 9A, the slide information providing apparatus may receive, from the slide tray slot, information indicating that a slide tray has been inserted in an incorrect direction, and may control a display to output a warning window indicating that a slide tray has been inserted in an incorrect direction. Information indicating that a slide tray has been inserted in an incorrect direction may comprise an identification number of the slide tray inserted in the incorrect direction and insertion guide information.

Referring to FIG. 9B, the slide information providing apparatus may receive, from the slide tray slot, information indicating that a slide tray has been inserted into a tray position in which scanning is in progress, and may control the display to output a warning window indicating that a slide tray has been inserted into the tray position in which scanning is in progress. Information indicating that a slide tray has been inserted into the tray position in which scanning is in progress may comprise an identification number of the slide tray that has been incorrectly inserted and insertion guide information.

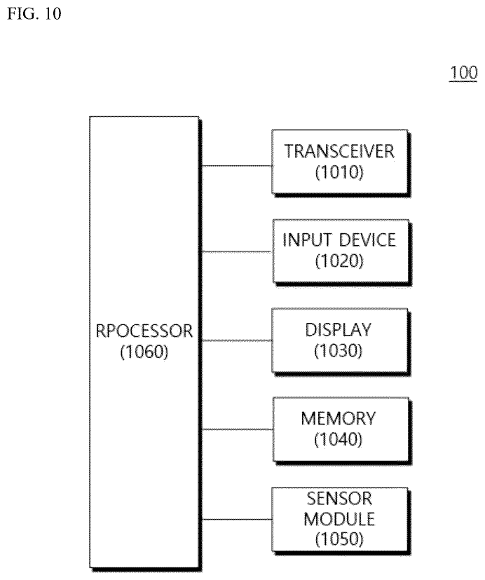

FIG. 10 is a block diagram of a slide tray slot according to an embodiment of the present disclosure.

Referring to FIG. 10, a slide tray slot 100 may comprise a transceiver 1010, an input device 1020, a display 1030, a memory 1040, a sensor module 1050, and a processor 1060. However, the slide tray slot 100 is not limited to the components illustrated in FIG. 10 and may comprise more components, or only some of the illustrated components. For example, the transceiver 1010, the input device 1020, the display 1030, the memory 1040, the sensor module 1050, and the processor 1060 may be implemented in the form of a single chip.

In one embodiment, the transceiver 1010 may communicate, in a wired or wireless manner, with at least one of a slide scan apparatus, the slide information providing apparatus, a user terminal, or another electronic device, which are connected to the slide tray slot 100. For example, the slide tray slot 100 may transmit, to the slide scan apparatus or the slide information providing apparatus, information indicating that slide trays are properly mounted in the slide tray slot 100, information regarding the slide trays, and the like.

In one embodiment, the input device 1020 may comprise, for example, a touch panel, a key pad, a button, a mouse, a trackball, a joystick, a wheel, an ultrasonic input device, a pen sensor, and the like. For example, after slide trays have been inserted into the slide tray slot 100, the input device 1020 may receive a user input for emitting a light source from a light source generator.

The display 1030 may comprise a panel, a hologram device, a projector, or the like. The slide tray slot 100 may, through the display 1030, output information indicating whether slide trays are properly mounted in the slide tray slot and information on positions of slide-tray accommodation units in which slide trays are not properly mounted.

A variety of types of data, such as programs and files including applications, may be recorded and stored in the memory 1040. The processor 1060 may access and use data stored in the memory 1040, or may generate new data and store the new data in the memory 1040. In one embodiment, the memory 1040 may comprise a database.

In one embodiment, the sensor module 1050 may, for example, measure a physical quantity or detect a state of the slide tray slot 100 and may convert measured or detected information into an electrical signal. For example, the sensor module 1050 may comprise at least one of an optical sensor, a pressure sensor, a proximity sensor, a Hall sensor, and the like. In addition, the sensor module 1050 may detect whether a slide tray is accommodated in each of a plurality of slide-tray accommodation units and may deliver the detected information to the processor 1060.

The processor 1060 may control an overall operation of the slide tray slot 100 and may comprise at least one processor such as a central processing unit (CPU), a microcontroller unit (MCU), a graphics processing unit (GPU), or the like. The processor 1060 may control driving of the light source generator and a light source detection sensor and may determine, by using an output of the light source detection sensor, whether light emitted from the light source generator passes through the plurality of slide-tray accommodation units and is detected.

In one embodiment, a slide tray may comprise a transparent region through which a light source can pass. A portion of the slide tray at which light emitted from the light source generator reaches when the slide tray is properly mounted in the slide tray slot may be formed of a transparent material. On the other hand, when the slide tray is not properly mounted in the slide tray slot, for example when the slide tray is inserted in an upside-down direction, light emitted from the light source generator may be blocked by an opaque region and may not reach a light source detection device.

In addition, in one embodiment, one surface of the slide tray may comprise a light-reflective region. After a light source is emitted by the light source generator, when the light is not detected by a light source detection sensor, the processor 1060 may determine a distance between the light source generator and the one surface of the slide tray on the basis of light reflected by the light-reflective region and detected by a second light source detection sensor. For example, the processor 1060 may determine the distance based on a difference between a time at which light is emitted from the light source generator and a time at which light reflected by the light-reflective region is detected by the second light source detection sensor. The processor 1060 may identify a position of a slide-tray accommodation unit or a slide tray that is not properly mounted in the slide tray slot based on the distance, and may output, to a display, information on the position, or may output, as a voice, information on a position of a slide-tray accommodation unit or a slide tray that is not properly mounted in the slide tray slot.

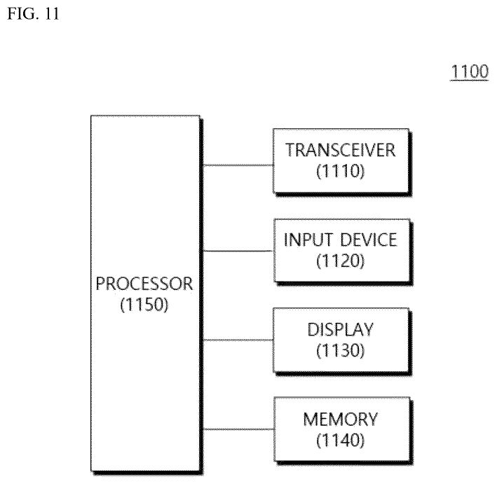

FIG. 11 is a block diagram of a slide information providing apparatus according to an embodiment of the present disclosure.

Referring to FIG. 11, a slide information providing apparatus 1100 may comprise a transceiver 1110, an input device 1120, a display 1130, a memory 1140, and a processor 1150. However, the slide information providing apparatus 1100 is not limited to the components illustrated in FIG. 11 and may comprise more components, or only some of the illustrated components. For example, the transceiver 1110, the input device 1120, the display 1130, the memory 1140, and the processor 1150 may be implemented in the form of a single chip.

In one embodiment, the transceiver 1110 may communicate, in a wired or wireless manner, with at least one of the slide tray slot 100, a slide scan apparatus, a user terminal, or another electronic device, which are connected to the slide information providing apparatus 1100. For example, the slide information providing apparatus 1100 may receive, from the slide tray slot 100, color information of light emitted by light-emitting elements of respective slide-tray accommodation units of the slide tray slot.

In one embodiment, the input device 1120 may comprise, for example, a touch panel, a key pad, a button, a mouse, a trackball, a joystick, a wheel, an ultrasonic input device, a pen sensor, and the like. In particular, the input device 1120 may comprise a touch panel for receiving a user input through various GUIs.

In one embodiment, the display 1130 may comprise, for example, a panel, a hologram device, or a projector. The display 1130 may output various GUIs including the first GUI 510, the second GUI 520, and the third GUI 530. When the display 1130 is configured as a touch screen, the display 1130 may be used not only as an output device but also as an input device. A variety of types of data, such as programs and files including applications, may be recorded and stored in the memory 1140. The processor 1150 may access and use data stored in the memory 1140, or may generate new data and store the new data in the memory 1140. In one embodiment, the memory 1140 may comprise a database.

The processor 1150 may control an overall operation of the slide information providing apparatus 1100 and may comprise at least one processor such as a central processing unit (CPU) or a graphics processing unit (GPU). The processor 1150 may, by executing programs stored in the memory 1140, identify at least one slide tray inserted into a slide tray slot, generate a first GUI regarding a slide tray based on the identified at least one slide tray, identify at least one slide arranged in each of the at least one slide tray, generate a second GUI regarding slides based on the identified at least one slide, and control the display to output the first GUI 510 and the second GUI 520.

An embodiment of the present disclosure may be implemented in the form of a computer-readable recording medium on which computer-readable instructions, data structures, or program modules such as program modules executed by a computer are recorded. A computer-readable medium may comprise volatile and non-volatile media and removable and non-removable media, and may comprise any information delivery medium that can store information to be accessed by a computer.

The above description of the present disclosure is merely illustrative, and it will be understood by those skilled in the art to which the present disclosure pertains that various changes in form and details may be made without departing from the technical spirit or essential features of the present disclosure. Therefore, the scope of the present disclosure is defined by the appended claims rather than by the foregoing detailed description, and all changes or modifications derived from the meanings and scope of the claims and their equivalents are to be construed as being included within the scope of the present disclosure. In addition, although components have been described as being combined in one embodiment, such components may be implemented in a distributed manner, and, likewise, components described as being distributed may be implemented in a combined form.

The scope of the present disclosure is indicated by the claims described below rather than by the foregoing detailed description, and it should be interpreted that all changes or modifications derived from the meanings and scope of the claims and their equivalents are included within the scope of the present disclosure.

1. An apparatus for providing slide information, the apparatus comprising:
a memory configured to store one or more instructions; and
at least one processor configured to execute the one or more instructions stored in the memory,
wherein the at least one processor, by executing the one or more instructions, is configured to:
identify at least one slide tray inserted into a slide tray slot;
generate a first graphical user interface (GUI) regarding slide trays based on the identified at least one slide tray;
identify at least one slide arranged in each of the at least one slide tray;
generate a second GUI regarding slides based on the identified at least one slide; and
control a display to output the first GUI and the second GUI.

2. The apparatus of claim 1,
wherein the first GUI comprises a GUI representing at least one of:
position information of the at least one slide tray inserted into the slide tray slot;
scan-progress information for at least a portion of the at least one slide tray;
slide-tray absence information;
identification information of a slot;
identification information of a slide tray accommodation unit; or
identification information of the at least one slide tray;
and the second GUI comprises a GUI representing at least one of:
position information of the at least one slide on the slide tray;
scan-progress information for at least a portion of the at least one slide;
specimen information of the at least one slide;
code information of the at least one slide;
identification information of the slide tray; or
identification information of the at least one slide.

3. The apparatus of claim 1,
wherein the at least one processor is configured to:
obtain a first user input for selecting a first slide tray among the at least one slide tray based on the first GUI;
control the display to output a second GUI corresponding to the first slide tray based on the first user input, the second GUI comprising identification information of the first slide tray; and
wherein the identification information of the first slide tray comprises at least one of:
position information indicating a position of the first slide tray within the slide tray slot;
scan-status information;
information on the number of slides included in the first slide tray; or
time information indicating when the first slide tray was inserted into the slide tray slot.

4. The apparatus of claim 1,
wherein the first GUI comprises a GUI representing at least one of:
a GUI corresponding to a first slide tray whose scanning is completed;
a GUI corresponding to a second slide tray that is being scanned;
a GUI corresponding to a third slide tray whose pre-scanning is completed or is in progress;
a GUI corresponding to a fourth slide tray for which scanning has not yet been performed;
a GUI indicating that no slide tray is present in a slide-tray accommodation unit; or
a GUI indicating a slide tray that is not a scanning target;
wherein the GUI corresponding to the second slide tray comprises a GUI indicating a degree of scanning progress for slides present in the second slide tray; and
wherein the GUI corresponding to the third slide tray may comprise a GUI indicating a degree of pre-scanning progress for slides present in the third slide tray.

5. The apparatus of claim 1,
wherein the first GUI comprises a GUI regarding a queue-management mode,
and wherein the at least one processor is configured to provide a GUI for changing an order of scanning or pre-scanning of slide trays when the GUI regarding the queue-management mode is selected.

6. The apparatus of claim 1,
wherein the second GUI comprises a GUI representing at least one of:
a GUI corresponding to a first slide whose scanning is completed;
a GUI corresponding to a second slide that is being scanned;
a GUI corresponding to a third slide for which scanning has not yet been performed;
a GUI indicating that no slide is present in a slide-accommodation unit; or
a GUI indicating a slide that is not a scanning target;
and wherein the GUI corresponding to the second slide comprises a GUI indicating a degree of scanning progress for the second slide.

7. The apparatus of claim 1,
wherein the at least one processor is configured to:
control the display to output a third GUI for selecting not a first slide tray but a second slide tray,
when a slide tray corresponding to information currently output through the second GUI is the first slide tray;
obtain a second user input for selecting the second slide tray while the second GUI regarding the first slide tray is being output;
update the first GUI, the second GUI, and the third GUI based on the second user input; and
control the display to output the updated first GUI, the updated second GUI, and the updated third GUI;
wherein the second user input comprises at least one of:
a user input touching a GUI corresponding to the second slide tray in the first GUI;
a user input touching a GUI corresponding to the second slide tray in the third GUI; or
a gesture input dragging the display from one direction to another;
and wherein, before being updated, the first GUI comprises a fourth GUI corresponding to the first slide tray and a fifth GUI corresponding to the second slide tray, the fifth GUI being smaller than the fourth GUI;
and wherein the updated first GUI comprises a fourth GUI corresponding to the first slide tray and a fifth GUI corresponding to the second slide tray, the fifth GUI being larger than the fourth GUI.

8. The apparatus of claim 1,
wherein the at least one processor is configured to:
identify a color corresponding to each of the slide trays in the first GUI; and
transmit a signal to the slide tray slot to control light-emitting elements of each slide-tray accommodation unit of the slide tray slot to emit light having a color corresponding to the color corresponding to each of the slide trays in the first GUI.

9. The apparatus of claim 1,
wherein the at least one processor is configured to:
receive, from the slide tray slot, color information of light emitted by light-emitting elements of each slide-tray accommodation unit of the slide tray slot; and
control the display, based on the color information, to output at least a portion of the first GUI corresponding to each of the slide trays in a color corresponding to the color of light emitted by the light-emitting elements of the corresponding slide-tray accommodation unit.

10. A method for providing slide information, the method comprising:
identifying at least one slide tray inserted into a slide tray slot;
generating a first graphical user interface (GUI) regarding slide trays based on the identified at least one slide tray;
identifying at least one slide arranged in each of the at least one slide tray;
generating a second GUI regarding slides based on the identified at least one slide; and
controlling a display to output the first GUI and the second GUI.

11. The method of claim 10,
wherein the first GUI comprises a GUI representing at least one of:
position information of the at least one slide tray inserted into the slide tray slot;
scan-progress information for at least a portion of the at least one slide tray;
slide-tray absence information;
identification information of a slot;
identification information of a slide tray accommodation unit; or
identification information of the at least one slide tray;
and the second GUI comprises a GUI representing at least one of:
position information of the at least one slide on the slide tray;
scan-progress information for at least a portion of the at least one slide;
specimen information of the at least one slide;
code information of the at least one slide;
identification information of the slide tray; or
identification information of the at least one slide.

12. The method of claim 10, wherein the method comprises:
obtaining a first user input for selecting a first slide tray among the at least one slide tray based on the first GUI; and
controlling the display to output a second GUI corresponding to the first slide tray based on the first user input, the second GUI comprising identification information of the first slide tray;
and wherein the identification information of the first slide tray comprises at least one of:
position information indicating a position of the first slide tray within the slide tray slot;
scan-status information;
information on the number of slides included in the first slide tray; or
time information indicating when the first slide tray was inserted into the slide tray slot.

13. The method of claim 10,
wherein the first GUI comprises a GUI regarding a queue-management mode,
and wherein the method comprises providing a GUI for changing an order of scanning or pre-scanning of slide trays when the GUI regarding the queue-management mode is selected.

14. The method of claim 10, wherein the method comprises:
controlling the display to output a third GUI for selecting not a first slide tray but a second slide tray,
when a slide tray corresponding to information currently output through the second GUI is the first slide tray;
obtaining a second user input for selecting the second slide tray while the second GUI regarding the first slide tray is being output;
updating the first GUI, the second GUI, and the third GUI based on the second user input; and
controlling the display to output the updated first GUI, the updated second GUI, and the updated third GUI;
wherein the second user input comprises at least one of:
a user input touching a GUI corresponding to the second slide tray in the first GUI;
a user input touching a GUI corresponding to the second slide tray in the third GUI; or
a gesture input dragging the display from one direction to another;
and wherein, before being updated, the first GUI comprises a fourth GUI corresponding to the first slide tray and a fifth GUI corresponding to the second slide tray, the fifth GUI being smaller than the fourth GUI;
and wherein the updated first GUI comprises a fourth GUI corresponding to the first slide tray and a fifth GUI corresponding to the second slide tray, the fifth GUI being larger than the fourth GUI.

15. The method of claim 10, wherein the method comprises:
identifying a color corresponding to each of the slide trays in the first GUI; and
transmitting a signal to the slide tray slot to control light-emitting elements of each slide-tray accommodation unit of the slide tray slot to emit light having a color corresponding to the color corresponding to each of the slide trays in the first GUI.
